(19) United States
(12) Patent Application Publication
(10) Pub. No.: US 2014/0105591 A1
(43) Pub. Date: Apr. 17, 2014

(54) Grip And Trigger For Devices

(71) Applicant: Stephen Lewis Van Norman, Orangevale, CA (US)

(72) Inventor: Stephen Lewis Van Norman, Orangevale, CA (US)

(21) Appl. No.: 13/652,751

(22) Filed: Oct. 16, 2012

(51) Int. Cl. G03B 17/00

(52) U.S. Cl. 396/544

(57) ABSTRACT

A grip and trigger apparatus including a handle housing, a device holder, a trigger member, and an actuation assembly is provided. The handle housing includes detachably attached casing members that define an enclosed space and openings. The device holder is positioned on the handle housing for securely accommodating the electronic device. The trigger member is operably connected to the actuation assembly within the enclosed space for triggering movement of the actuating assembly in an upward and downward direction. The actuation assembly includes an elongate member extending out of an opening defined by the handle housing, and an actuation head member rigidly connected to an upper end of the elongate member. The actuation head member comprises a protruding element that applies a downward pressure on a button of the electronic device for actuating the electronic device, when the trigger member triggers the movement of the actuation assembly in a downward direction.

### CROSS REFERENCE TO RELATED APPLICATIONS

This application claims the benefit of provisional patent application No. 61/553,303 titled “Grip and Trigger Attachment for a Camera”, filed in the United States Patent and Trademark Office on Oct. 31, 2011.

The specification of the above referenced patent application is incorporated herein by reference in its entirety.

### BACKGROUND

There are a variety of electronic devices in the market, for example, cameras which are widely used for applications such as voice recording, photography, etc. As technology developed and improved over the years, such electronic devices have become more compact and more affordable for most users.

While digital photography has reduced the cost of capturing an image, handling and actuating typical digital cameras to capture an image has become more difficult due to the small sized buttons and controls on these digital cameras. A user typically has to hold a camera near his/her face, struggle with operating controls of the camera, and search for a shutter release button to capture an image which often is not a user friendly task. Moreover, when all of these activities have been performed, the opportunity for capturing a good quality image may have passed. Furthermore, users who are elderly, disabled, or have the use of only one hand may find it difficult to handle the camera and capture an image. Therefore, there is a need for an apparatus that provides grip and enables a user to conveniently handle a camera with one hand and quickly and efficiently capture an image.

Moreover, most users find a shutter release button that is located on an upper surface of a camera difficult to operate, while handling the camera. Although touch screen activated shutter release devices are also available, most users prefer actuating a shutter release button on the camera. Therefore, there is a need for an apparatus that triggers an externally positioned shutter release button on a camera with minimal effort from a user.

Hence, there is a long felt but unresolved need for a grip and trigger apparatus that is removably attachable to an electronic device, for example, a digital camera, that provides grip to a user's hand while the user performs an action such as capturing an image, and that triggers an external button on the electronic device for convenient actuation of the electronic device.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The apparatus and method disclosed herein address the above mentioned need for a grip and trigger apparatus removably attachable to an electronic device for actuating the electronic device. The electronic device is, for example, a voice recorder, a handheld camera, etc. The grip and trigger apparatus provides grip to a user's hand while the user performs an action such as capturing an image using an electronic device. The grip and trigger apparatus triggers an external button on the electronic device for convenient actuation of the electronic device.

The grip and trigger apparatus disclosed herein comprises a handle housing, a device holder, a trigger member, and an actuation assembly. The handle housing comprises a first casing member detachably attached to a second casing member. The detachably attached first casing member and the second casing member of the handle housing are configured to define an enclosed space and openings for accommodating the trigger member and the actuation assembly. In an embodiment, each of the first casing member and the second casing member of the handle housing comprises an enlarged opening of a predefined shape. Each enlarged opening of the detachably attached first casing member and the second casing member defines an access region configured to accommodate a user's hand. In another embodiment, the inner edges that define each enlarged opening of the detachably attached the first casing member and the second casing member of the handle housing are configured to form a gripping section. The gripping section is configured to conform to the user's fingers and to allow the user's fingers to grip the handle housing.

The device holder is positioned on an upper surface of the handle housing. The device holder is configured to securely accommodate the electronic device. The device holder comprises a receptacle configured to accommodate the electronic device. In an embodiment, the grip and trigger apparatus disclosed herein further comprises a clamping assembly positioned within the receptacle of the device holder. The clamping assembly is configured to securely accommodate and clamp the electronic device. The trigger member extends outwardly from a side of the handle housing via one of the openings defined by the handle housing. The trigger member is operably connected to the actuation assembly within the enclosed space defined within the handle housing. The trigger member is configured to trigger movement of the actuation assembly in an upward direction and a downward direction, when pressed by a user. The grip and trigger apparatus disclosed herein further comprises a spring member coaxially positioned along a length of the trigger member. The spring member is configured to facilitate advance and retraction of the trigger member for moving the actuation assembly in an upward direction and a downward direction.

In an embodiment, the grip and trigger apparatus disclosed herein further comprises a coupling member positioned within a cavity defined in the second casing member of the handle housing. The coupling member is configured to operably connect the trigger member to the actuation assembly within the enclosed space defined within the handle housing. The coupling member comprises a first connector and a second connector. The first connector is rollably connected to a through hole positioned at one opposing end of the trigger member. The second connector is rollably connected to a through hole positioned at a lower end of the elongate member of the actuation assembly. The first connector of the coupling member is configured to roll within the through hole of the trigger member and opposingly slide the coupling member in a horizontal direction within the cavity of the second casing member, causing the second connector of the coupling member to roll within the through hole of the elongate member of the actuation assembly and opposingly slide the coupling member in a vertical direction within the cavity of the second casing member for moving the actuation assembly in an upward direction and a downward direction.

The actuation assembly is positioned in another opening defined by the handle housing. The actuation assembly comprises an elongate member and an actuation head member. The elongate member is slidably positioned within the enclosed space and extends out of the other opening defined by the handle housing. The actuation head member is rigidly connected to an upper end of the elongate member. The actuation head member comprises a protruding element configured to apply a downward pressure on a button of the electronic device for actuating the electronic device, when the trigger member triggers movement of the actuation assembly in a downward direction. In an embodiment, the grip and trigger apparatus disclosed herein further comprises a slider positioned proximal to the upper end of the elongate member of the actuation assembly. The slider is configured to adjust a position of the actuation head member of the actuation assembly. The grip and trigger apparatus disclosed herein is configured for temporary secure attachment to an electronic device, for example, a camera in order to provide a user with a convenient method for repeatedly actuating a button on the camera for capturing multiple images in a single sitting.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 exemplarily illustrates an isometric view of a grip and trigger apparatus.

FIG. 2 exemplarily illustrates an exploded view of the grip and trigger apparatus.

FIG. 3A exemplarily illustrates a front elevation view of the grip and trigger apparatus.

FIG. 3B exemplarily illustrates a rear elevation view of the grip and trigger apparatus.

FIG. 4A exemplarily illustrates a right side elevation view of the grip and trigger apparatus.

FIG. 4B exemplarily illustrates a left side elevation view of the grip and trigger apparatus.

FIG. 5A exemplarily illustrates a plan view of the grip and trigger apparatus.

FIG. 5B exemplarily illustrates a bottom view of the grip and trigger apparatus.

FIG. 6A exemplarily illustrates a front cutaway view of the grip and trigger apparatus, showing a protruding element of the actuation head member applying a downward pressure on an external button of an electronic device.

FIG. 6B exemplarily illustrates a front cutaway view of the grip and trigger apparatus, showing the protruding element of the actuation head member releasing the external button of the electronic device.

FIG. 7 exemplarily illustrates a front cutaway view of the grip and trigger apparatus, showing the actuation assembly folded into a slot positioned inside a handle housing of the grip and trigger apparatus.

FIG. 8A exemplarily illustrates an isometric view of a device holder of the grip and trigger apparatus, showing a clamping assembly configured to accommodate and clamp an electronic device.

FIG. 8B exemplarily illustrates a top view of the device holder of the grip and trigger apparatus, showing the clamping assembly configured to accommodate and clamp an electronic device.

FIG. 8C exemplarily illustrates a bottom view of the device holder of the grip and trigger apparatus, showing the clamping assembly configured to accommodate and clamp an electronic device.

FIG. 9 exemplarily illustrates a method for actuating an electronic device.

### DETAILED DESCRIPTION OF THE INVENTION

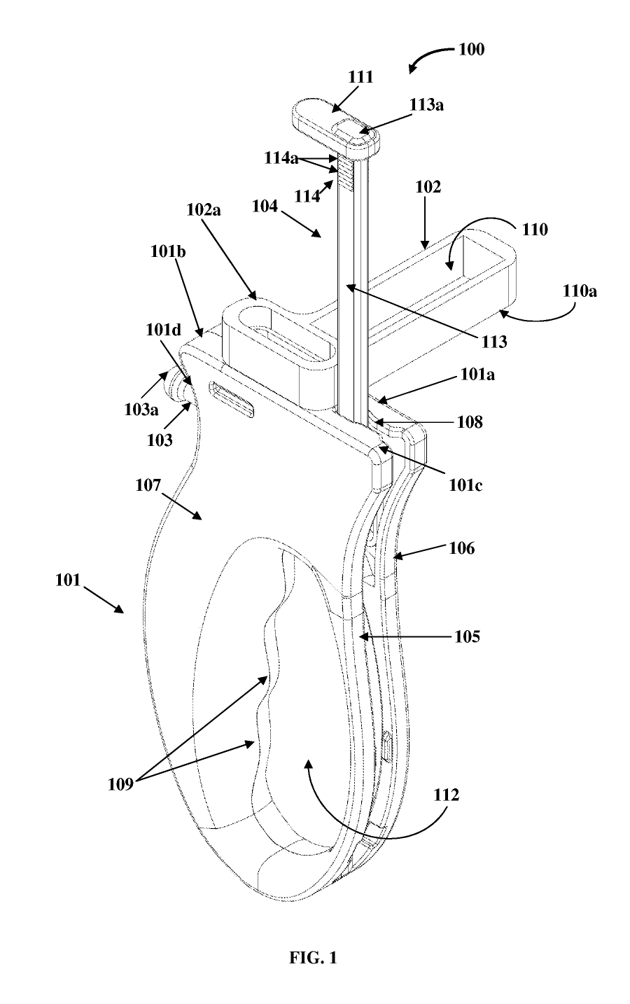

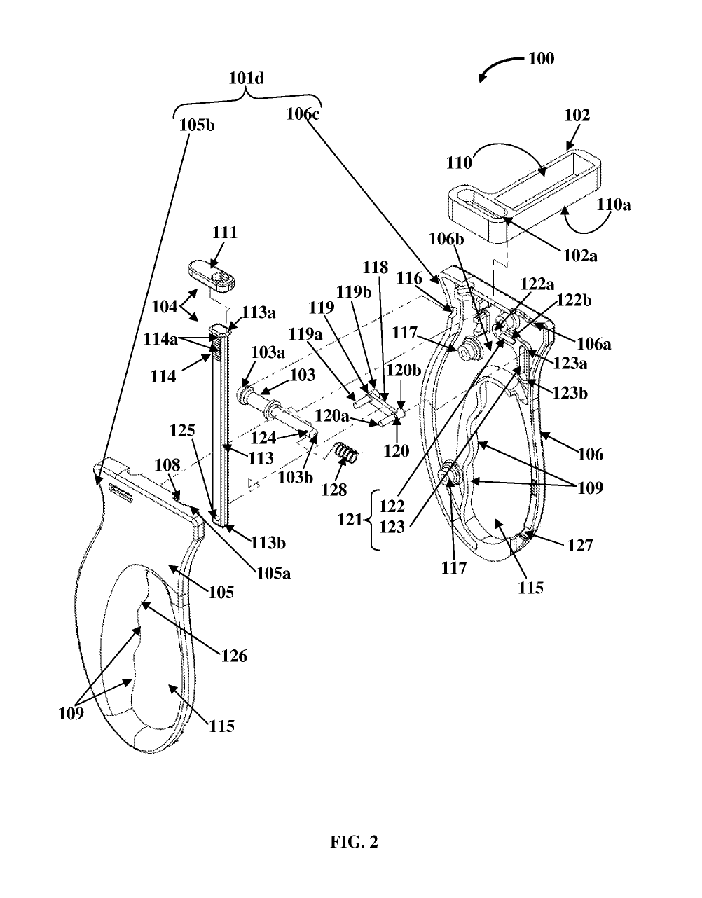

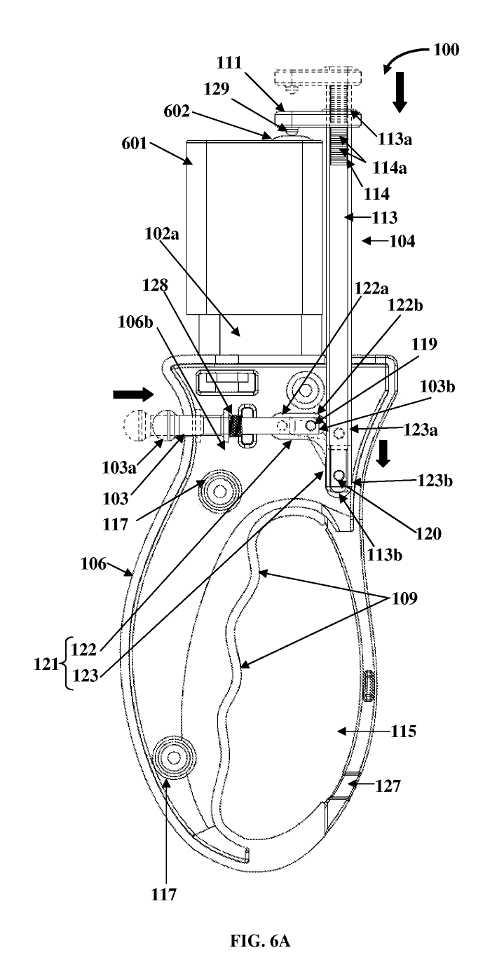

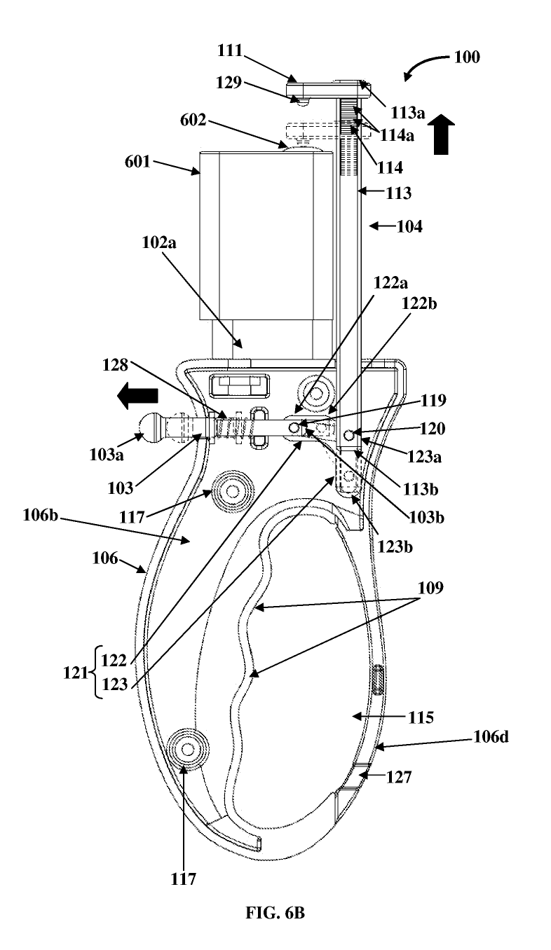

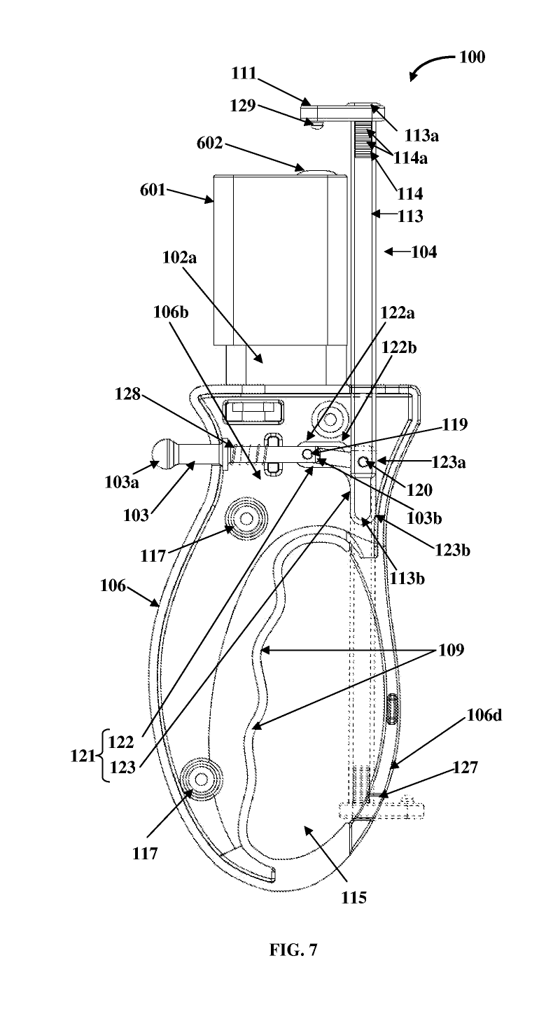

FIG. 1 exemplarily illustrates an isometric view of a grip and trigger apparatus 100. The grip and trigger apparatus 100 is removably attachable to an electronic device 601 as exemplarily illustrated in FIGS. 6A-6B and FIG. 7, for actuating the electronic device 601. The electronic device 601 is, for example, a voice recorder, a handheld camera, a cell phone, etc., having an external button 602 as exemplarily illustrated in FIGS. 6A-6B and FIG. 7. The grip and trigger apparatus 100 disclosed herein comprises a handle housing 101, a device holder 102, a trigger member 103, and an actuation assembly 104. The handle housing 101 is, for example, made of plastic, a metal, etc. The handle housing 101 comprises a first casing member 105 and a second casing member 106. The first casing member 105 is detachably attached to the second casing member 106. The detachably attached first casing member 105 and the second casing member 106 of the handle housing 101 are configured to define an enclosed space 107 and openings 108 and 116, as exemplarily illustrated in FIG. 2, for accommodating the actuation assembly 104 and the trigger member 103 respectively. The handle housing 101 is, for example, of an oval geometry.

In an embodiment, each of the first casing member 105 and the second casing member 106 of the handle housing 101 comprises an enlarged opening 115 of a predefined shape, for example, an oval shape as exemplarily illustrated in FIG. 2. Each enlarged opening 115 of the detachably attached first casing member 105 and the second casing member 106 defines an access region 112 exemplarily illustrated in FIG. 1, configured to accommodate a user's hand. The inner edges 126 defining each enlarged opening 115 of the detachably attached first casing member 105 and the second casing member 106 of the handle housing 101, exemplarily illustrated in FIG. 2, are configured to form a gripping section 109. The gripping section 109 is configured to conform to the user's fingers and to allow the user's fingers to grip the handle housing 101. The gripping section 109 comprises finger shaped contours that securely accommodate the user's fingers and provide comfort while gripping. The user can grip the grip and trigger apparatus 100 that securely accommodates the electronic device 601 via the gripping section 109.

The device holder 102 is positioned on an upper surface 101a of the handle housing 101. The device holder 102 is configured to securely accommodate the electronic device 601. The device holder 102 comprises a receptacle 110 configured to accommodate an electronic device 601 of any dimension, shape, and size. The receptacle 110 is configured to conform to the shape, dimension, and size of the electronic device 601. Although the detailed description refers to a single receptacle 110 in the device holder 102 as exemplarily illustrated in FIGS. 1-2, FIG. 5A, and FIGS. 8A-8C, the scope of the grip and trigger apparatus 100 disclosed herein may be extended to include two or more receptacles of predetermined sizes for accommodating two or more electronic devices 601 of different sizes. The electronic device 601 is positioned and securely accommodated in the receptacle 110 of the device holder 102. In an embodiment, a screw (not shown) is inserted through the bottom section 110a of the receptacle 110 into a threaded hole (not shown) configured in the electronic device 601 to fasten the electronic device 601 within the receptacle 110 of the device holder 102. The threaded hole of the electronic device 601 is configured, for example, for a tripod stand. In an embodiment, the device holder 102 comprises a connector section 102a configured to connect and fasten the device holder 102 to the handle housing 101. In an embodiment, a screw (not shown) positioned in the connector section 102a passes through the connector section 102a and into the handle housing 101, and fastens through a nut (not shown) disposed in the enclosed space 107 of the handle housing 101 to attach the device holder 102 to the handle housing 101.

The trigger member 103 extends outwardly from a side 101d of the handle housing 101 via an opening 116, exemplarily illustrated in FIG. 2, defined by the handle housing 101. The opening 116 is defined below the upper left end 101b of the handle housing 101. The trigger member 103 is positioned below the upper left end 101b of the handle housing 101 and extends out through the opening 116 on the side 101d of the handle housing 101. The trigger member 103 is operably connected to the actuation assembly 104 within the enclosed space 107 defined within the handle housing 101. The trigger member 103 is configured to trigger movement of the actuation assembly 104 in an upward direction and a downward direction.

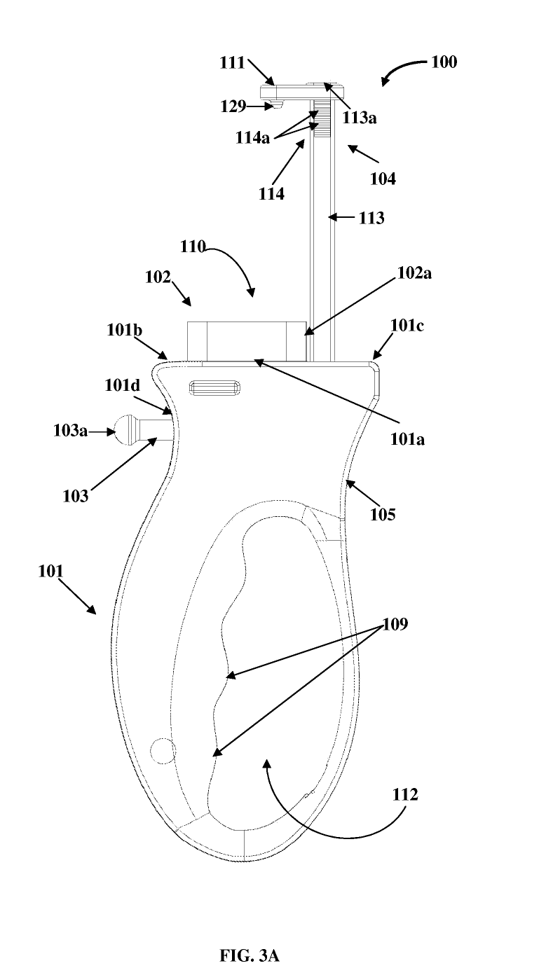

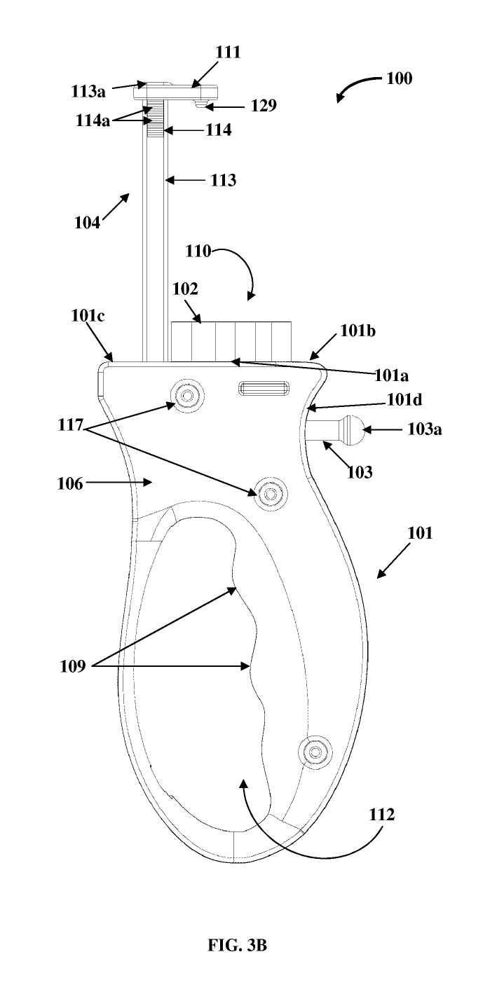

The actuation assembly 104 is positioned in another opening 108 defined by the handle housing 101. The opening 108 is defined at an upper right end 101c of the handle housing 101. The actuation assembly 104 comprises an elongate member 113 and an actuation head member 111. The elongate member 113 is slidably positioned within the enclosed space 107 and extends out of the opening 108 defined by the handle housing 101. The actuation head member 111 is rigidly connected to an upper end 113a of the elongate member 113. The actuation head member 111 is, for example, made of a rubber material, an elastic material, etc., that is configured to impart sufficient force to depress a button 602 without scratching or otherwise damaging the button 602 or the electronic device 601. The actuation head member 111 comprises a protruding element 129, as exemplarily illustrated in FIGS. 3A-3B, FIG. 4B, FIGS. 6A-6B, and FIG. 7, configured to apply a downward pressure on a button 602 of the electronic device 601 for actuating the electronic device 601, when the trigger member 103 triggers movement of the actuation assembly 104 in a downward direction.

The actuation head member 111 of the actuation assembly 104 is positioned over the receptacle 110 of the device holder 102. The electronic device 601 is securely accommodated within the receptacle 110 and when the trigger member 103 is pressed by a user, the actuation assembly 104 moves in a downward direction, thereby allowing the protruding element 129 of the actuation head member 111 to apply a downward pressure on the button 602 of the electronic device 601. When the user releases the trigger member 103, the trigger member 103 retracts and the actuation assembly 104 moves in an upward direction, thereby releasing the contact between the protruding element 129 and the external button 602, to configure the electronic device 601 in a standby mode for the next pressing operation of the trigger member 103.

In an embodiment, the grip and trigger apparatus 100 disclosed herein further comprises a slider 114 positioned proximal to the upper end 113a of the elongate member 113 of the actuation assembly 104 and below the actuation head member 111 of the actuation assembly 104. The slider 114 is configured to adjust a position of the actuation head member 111. The slider 114 is operably connected to the actuation head member 111 from within the elongate member 113. A user adjusts the height of the actuation head member 111 with respect to the external button 602 of the electronic device 601 using the slider 114. The user may use his/her thumb to grip the slider 114 and slide the slider 114 upwards and downwards to adjust the height of the actuation head member 111 according to the size or dimensions of the electronic device 601. The actuation head member 111 is adjusted by thumb pressure. The slider 114 extends out of the elongate member 113 of the actuation assembly 104 on application of a sliding force by the user's thumb to adjust the position of the actuation head member 111. The extension of the slider 114 is adjusted by moving the thumb along gripping linings 114a of the slider 114.

FIG. 2 exemplarily illustrates an exploded view of the grip and trigger apparatus 100. The grip and trigger apparatus 100 comprises the handle housing 101 as exemplarily illustrated in FIG. 1, the device holder 102, the trigger member 103, and the actuation assembly 104 as disclosed in the detailed description of FIG. 1. The handle housing 101 comprises the first casing member 105 and the second casing member 106 as disclosed in the detailed description of FIG. 1. The first casing member 105 and the second casing member 106 comprise an enlarged opening 115 of a predefined shape, for example, an oval shape. When the first casing member 105 and the second casing member 106 are fastened using fasteners 117, for example, screws positioned on an inner surface 106b of the second casing member 106, each enlarged opening 115 together defines the access region 112 exemplarily illustrated in FIG. 1, for accommodating the user's hand. Furthermore, when the first casing member 105 and the second casing member 106 are fastened using the fasteners 117, the gripping section 109 is defined along the inner edges 126 that define the enlarged openings 115. The gripping section 109 conforms to the user's fingers.

The upper edges 105a and 106a of the first casing member 105 and the second casing member 106 respectively, are cut out to create the opening 108 when the first casing member 105 and the second casing member 106 are attached. The opening 108 is configured to accommodate the elongate member 113 of the actuation assembly 104. The sides 105b and 106c of the first casing member 105 and the second casing member 106 respectively, are cut out to create the opening 116 when the first casing member 105 and the second casing member 106 are attached. The opening 116 is configured to accommodate the trigger member 103. The first casing member 105 and the second casing member 106 of the handle housing 101 are attached using the fasteners 117 positioned on the inner surface 106b of the second casing member 106.

The trigger member 103 is positioned horizontally through the opening 116, while the actuation assembly 104 is positioned vertically through the opening 108. In an embodiment, the grip and trigger apparatus 100 disclosed herein further comprises a coupling member 118 positioned between the trigger member 103 and the actuation assembly 104 inside the handle housing 101. The trigger member 103 is configured to actuate the actuation assembly 104 via the coupling member 118. The actuation assembly 104 receives the drive from the trigger member 103 through the coupling member 118. The coupling member 118 is positioned within a cavity 121 defined in the second casing member 106 of the handle housing 101. The cavity 121 is located below the upper edge 106a of the second casing member 106. The coupling member 118 is configured to operably connect the trigger member 103 to the actuation assembly 104 within the enclosed space 107 defined within the handle housing 101.

The coupling member 118 comprises a first connector 119 and a second connector 120. The first connector 119 is rollably connected to a through hole 124 positioned at one opposing end 103b of the trigger member 103. The trigger member 103 comprises a thumb end 103a and the through hole 124. The through hole 124 of the trigger member 103 is positioned at the opposing end 103b of the trigger member 103. The second connector 120 is rollably connected to a through hole 125 positioned at a lower end 113b of the elongate member 113 of the actuation assembly 104. The first connector 119 of the coupling member 118 is configured to roll within the through hole 124 of the trigger member 103 and opposingly slide the coupling member 118 in a horizontal direction within the cavity 121 of the second casing member 106, causing the second connector 120 of the coupling member 118 to roll within the through hole 125 of the elongate member 113 of the actuation assembly 104 and opposingly slide the coupling member 118 in a vertical direction within the cavity 121 of the second casing member 106 for moving the actuation assembly 104 in an upward direction and in a downward direction.

The first connector 119 comprises a frontal end 119a and a distal end 119b. The second connector 120 also comprises a frontal end 120a and a distal end 120b. The cavity 121 comprises a horizontal section 122 and a vertical section 123. The frontal end 119a of the first connector 119 is rollably connected to a through hole 124 positioned at one opposing end 103b of the trigger member 103. The distal end 119b of the first connector 119 is positioned, for example, at a left end 122a of the horizontal section 122 of the cavity 121 before the trigger member 103 is pressed. The frontal end 120a of the second connector 120 is rollably connected to a through hole 125 positioned at the lower end 113b of the elongate member 113 of the actuation assembly 104. The distal end 120b of the second connector 120 is positioned, for example, at an upper end 123a of the vertical section 123 of the cavity 121 before the trigger member 103 is pressed.

When the user presses the trigger member 103 using the thumb end 103a, the first connector 119 advances or moves forward along the direction of push and the second connector 120 moves perpendicular to the direction of the push resulting in the movement of the actuation assembly 104 in a downward direction. That is, the distal end 119b of the first connector 119 moves from the left end 122a to a right end 122b of the horizontal section 122 of the cavity 121, causing the distal end 120b of the second connector 120 to move from the upper end 123a of the vertical section 123 of the cavity 121 to a lower end 123b of the vertical section 123. As the frontal end 120a of the second connector 120 is rollably connected to the through hole 125 of the elongate member 113 of the actuation assembly 104, the actuation assembly 104 moves in a downward direction, when the trigger member 103 is pressed. The direction of movement of the actuation assembly 104 is reversed in an upward direction when the user releases the trigger member 103. A spring member 128 enables retraction of the trigger member 103 to its original position on release of the trigger member 103 by the user as disclosed in the detailed description of FIGS. 6A-6B. As the trigger member 103 is pressed by a user's thumb, the coupling member 118 converts the horizontal displacement of the trigger member 103 into a vertical displacement of the actuation assembly 104.

The actuation assembly 104 presses the external button 602 of the electronic device 601 accommodated within the receptacle 110 of the device holder 102 as exemplarily illustrated in FIGS. 6A-6B, when the trigger member 103 is pressed. The protruding element 129 housed on the actuation head member 111 of the actuation assembly 104 as exemplarily illustrated in FIGS. 3A-3B, FIG. 4B, FIGS. 6A-6B, and FIG. 7, presses or applies a downward pressure to the external button 602. The protruding element 129 is positioned in a vertically downward direction from the actuation head member 111 to apply a downward pressure on the external button 602 of the electronic device 601.

FIGS. 3A-3B exemplarily illustrate a front elevation view and a rear elevation view respectively, of the grip and trigger apparatus 100. FIGS. 3A-3B show the generally oval geometry of the handle housing 101 with the gripping section 109 configured to allow the user's fingers to grip the handle housing 101. The device holder 102 is fastened on the upper surface 101a of the handle housing 101 to accommodate the electronic device 601 as exemplarily illustrated in FIGS. 6A-6B and FIG. 7. The thumb end 103a of the trigger member 103 extends outwards from the side 101d of the handle housing 101 after the first casing member 105 and the second casing member 106 of the handle housing 101 are fastened. FIGS. 3A-3B also show the protruding element 129 of the actuation head member 111 that is configured to apply a downward pressure on the button 602 of the electronic device 601 for actuating the electronic device 601.

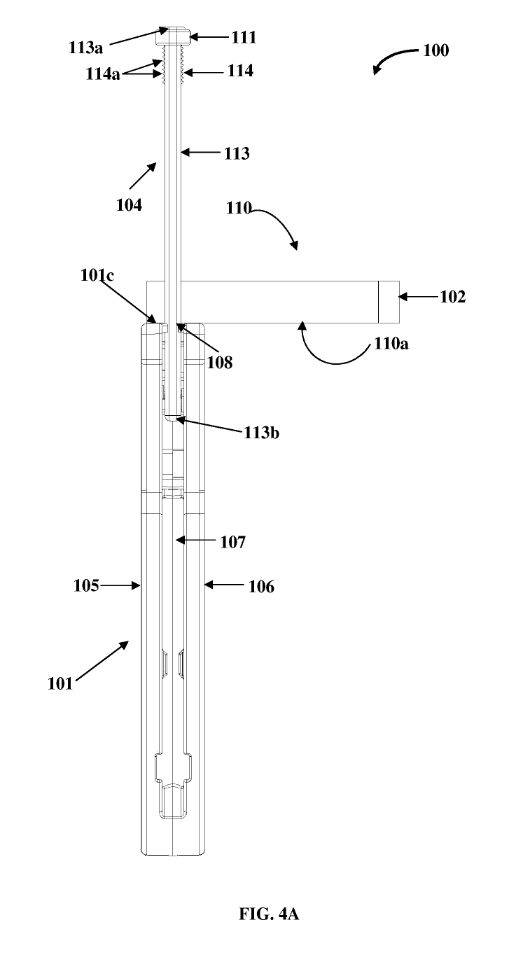

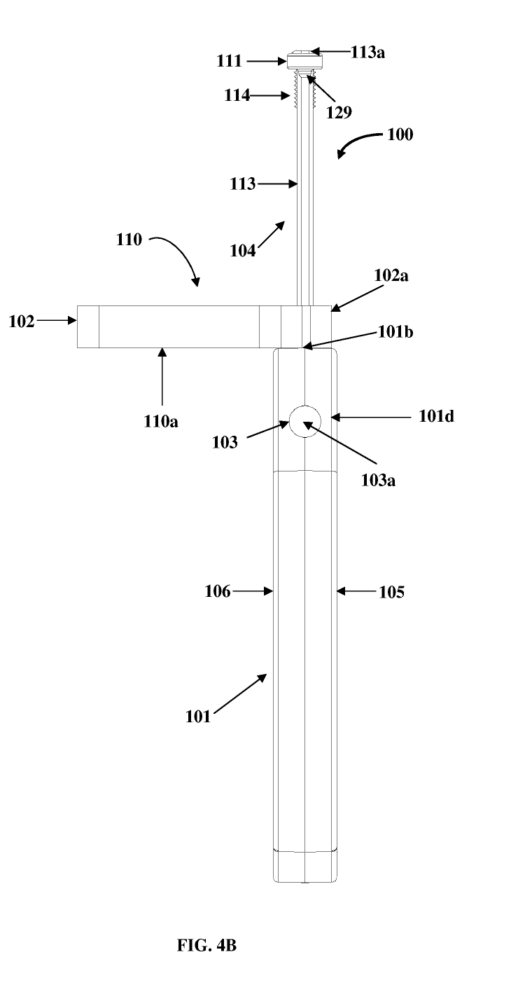

FIGS. 4A-4B exemplarily illustrate a right side elevation view and a left side elevations view respectively, of the grip and trigger apparatus 100. The first casing member 105 and the second casing member 106 are attached to each other to define the enclosed space 107 within the handle housing 101. The elongate member 113 of the actuation assembly 104 vertically extends from within the enclosed space 107 towards the outside of the handle housing 101.

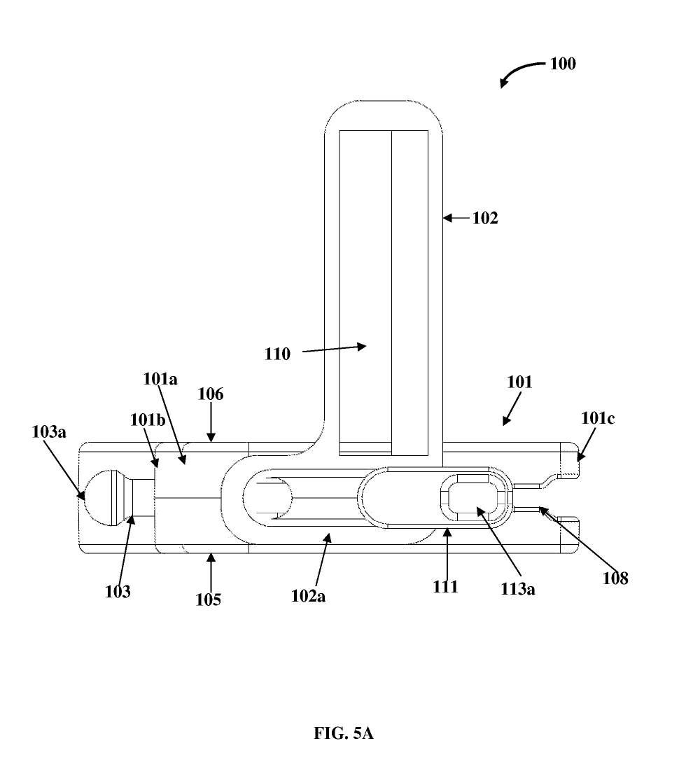

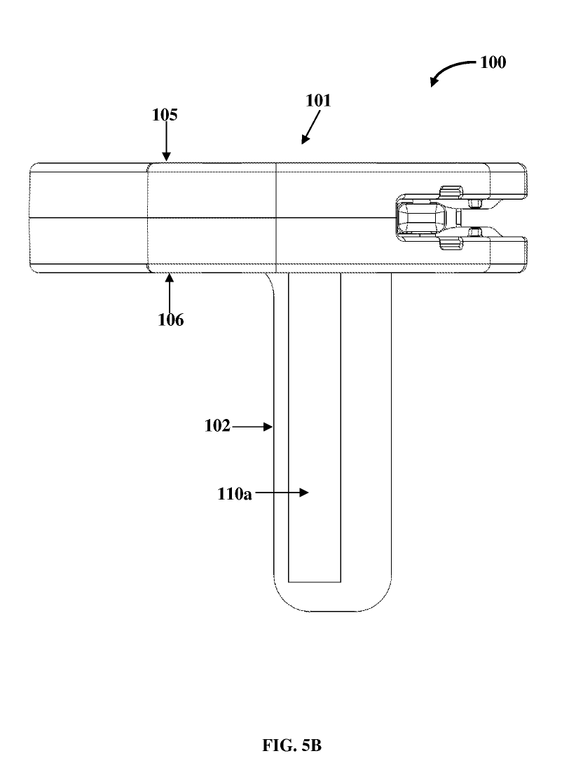

FIGS. 5A-5B exemplarily illustrate a plan view and a bottom view respectively, of the grip and trigger apparatus 100. The receptacle 110 of the device holder 102 is configured to accommodate the electronic device 601 as exemplarily illustrated in FIGS. 6A-6B and FIG. 7. Electronic devices 601 of a range of sizes can be accommodated in the receptacle 110 of the device holder 102.

FIGS. 6A-6B exemplarily illustrate a front cutaway view of the grip and trigger apparatus 100. FIG. 6A exemplarily illustrates a protruding element 129 of the actuation head member 111 applying a downward pressure on an external button 602, for example, a shutter release button of an electronic device 601, for example, a camera. The grip and trigger apparatus 100 disclosed herein further comprises a spring member 128 coaxially positioned along a length of the trigger member 103. The spring member 128 is configured to facilitate the advance and retraction of the trigger member 103 for moving the actuation assembly 104 in an upward direction and a downward direction. The protruding element 129 of the actuation head member 111 applies a downward pressure on the external button 602 against a compression resistance from the spring member 128 coaxially positioned along the length of the trigger member 103. When the user presses the trigger member 103, the coaxially positioned spring member 128 is compressed and the first connector 119 of the coupling member 118, exemplarily illustrated in FIG. 2, moves from the left end 122a of the horizontal section 122 of the cavity 121 to the right end 122b of the horizontal section 122 of the cavity 121. Furthermore, the second connector 120 of the coupling member 118 moves from the upper end 123a of the vertical section 123 of the cavity 121 to the lower end 123b of the vertical section 123 of the cavity 121 in a downward direction. The movement of the second connector 120 of the coupling member 118 in the downward direction causes the actuation assembly 104 to move in a downward direction, thereby allowing the protruding element 129 positioned on the actuation head member 111 to press the external button 602 of the electronic device 601 and actuate the electronic device 601, for example, to capture an image.

FIG. 6B exemplarily illustrates the protruding element 129 of the actuation head member 111 releasing the external button 602 of the electronic device 601. The protruding element 129 of the actuation head member 111 releases the external button 602 by decompression of the spring member 128 coaxially positioned along the length of the trigger member 103. The term “decompression” refers to the release of a compression force from a compressed element, for example, the spring member 128. When the user releases the pressing force from the trigger member 103, the trigger member 103 retracts to its original position. The retraction motion of the trigger member 103 causes the first connector 119 of the coupling member 118 to move back from the right end 122b of the horizontal section 122 of the cavity 121 to the left end 122a of the horizontal section 122 of the cavity 121, and causes the second connector 120 of the coupling member 118 to move from the lower end 123b of the vertical section 123 of the cavity 121 to the upper end 123a of the vertical section 123 of the cavity 121 in an upward direction. The movement of the second connector 120 of the coupling member 118 in the upward direction causes the actuation assembly 104 to move in an upward direction, thereby allowing the protruding element 129 positioned on the actuation head member 111 to release the downward pressure on the external button 602 of the electronic device 601.

FIG. 7 exemplarily illustrates a front cutaway view of the grip and trigger apparatus 100, showing the actuation assembly 104 folded into a slot 127 positioned inside the handle housing 101 of the grip and trigger apparatus 100. In an embodiment, after the user uses the grip and trigger apparatus 100 for actuating an electronic device 601, the user can fold and store the actuation assembly 104 inside the handle housing 101 by detaching the first casing member 105 from the second casing member 106, disconnecting the actuation assembly 104 from the second connector 120 of the coupling member 118 exemplarily illustrated in FIG. 2, rotating and downwardly folding the actuation assembly 104, such that actuation head member 111 of the actuation assembly 104 securely fits into the slot 127 configured at the side 106d of the second casing member 106 of the handle housing 101. The actuation assembly 104 is tilted through a 180 degree angle with respect to the upper end 123a of the vertical section 123 of the cavity 121 defined in the second casing member 106 of the handle housing 101 to fold the actuation assembly 104. On folding the actuation assembly 104, the actuation head member 111 securely fits into the slot 127 configured at the side 106d of the second casing member 106 of the handle housing 101.

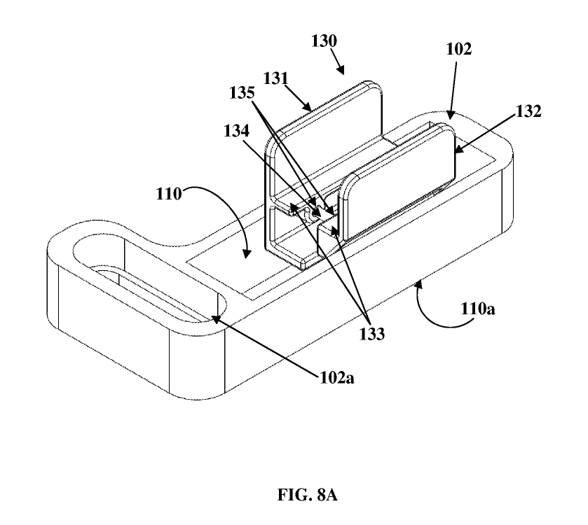

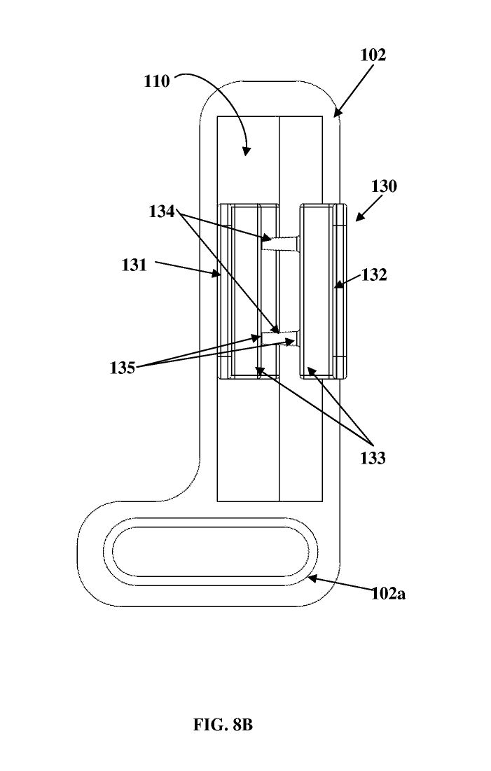

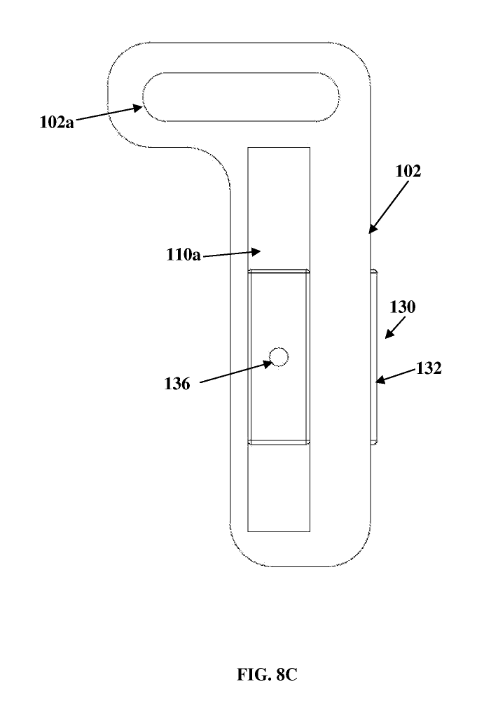

FIGS. 8A-8C exemplarily illustrate an isometric view, a top view, and a bottom view respectively, of the device holder 102 of the grip and trigger apparatus 100, showing a clamping assembly 130 configured to accommodate and clamp an electronic device 601 exemplarily illustrated in FIGS. 6A-6B and FIG. 7, for example, a cell phone or any other device which does not have a threaded hole for attaching a tripod. In an embodiment, the grip and trigger apparatus 100 disclosed herein further comprises the clamping assembly 130 positioned within the receptacle 110 of the device holder 102. The clamping assembly 130 is configured to securely accommodate and clamp the electronic device 601. The clamping assembly 130 is attached to the receptacle 110 of the device holder 102, for example, using a screw 136 inserted from the bottom section 110a of the receptacle 110 into a threaded nut (not shown) contained in the clamping assembly 130 as exemplarily illustrated in FIG. 8C. The clamping assembly 130 comprises a first clamp 131 and a second clamp 132 configured to define a seating region 133 therebetween for accommodating the electronic device 601. A shaft element 134 connects the first clamp 131 and the second clamp 132 via extended through holes 135 positioned on the first clamp 131 and the second clamp 132.

The user mounts the electronic device 601 into the seating region 133 defined between the first clamp 131 and the second clamp 132. The user then applies a hand pressure either at the first clamp 131 or at the second clamp 132. The first clamp 131 slides along the shaft element 134 and detachably fixes the electronic device 601 between the first clamp 131 and the second clamp 132. The clamping assembly 130 thereby sandwiches the electronic device 601 in the device holder 102. After clamping the electronic device 601 within the clamping assembly 130, the user may then press the external button 602 of the electronic device 601 using the actuation assembly 104 of the grip and trigger apparatus 100 as exemplarily illustrated in FIGS. 6A-6B and FIG. 7. The protruding element 129 of the actuation head member 111, as exemplarily illustrated in FIGS. 3A-3B, FIG. 4B, FIGS. 6A-6B, and FIG. 7, is configured to apply a downward pressure on the external button 602 of the electronic device 601 for actuating the electronic device 601 when the trigger member 103 triggers movement of the actuation assembly 104 in a downward direction as exemplarily illustrated in FIG. 6A.

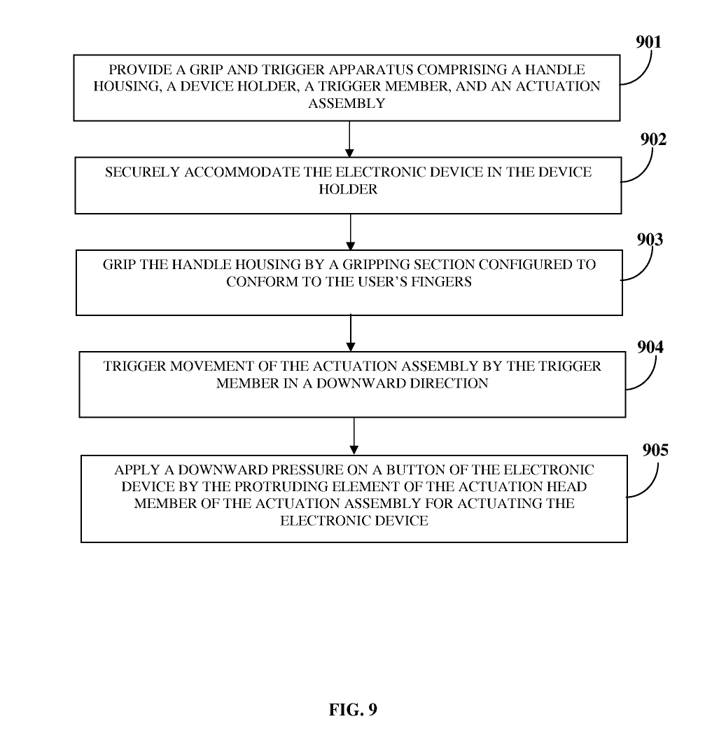

FIG. 9 exemplarily illustrates a method for actuating an electronic device 601 as exemplarily illustrated in FIGS. 6A-6B and FIG. 7. In the method disclosed herein, the grip and trigger apparatus 100 comprising the handle housing 101, the device holder 102, the trigger member 103, and the actuation assembly 104 as exemplarily illustrated in FIGS. 1-2 is provided 901. The actuation assembly 104 comprises the elongate member 113 and the actuation head member 111. The device holder 102 securely accommodates 902 the electronic device 601 in a receptacle 110 of the device holder 102. In an embodiment, the electronic device 601 is clamped within the receptacle 110 of the device holder 102 by a clamping assembly 130 positioned within the receptacle 110 of the device holder 102 as disclosed in the detailed description of FIGS. 8A-8C. A user grips 903 the handle housing 101 by the gripping section 109 configured to conform to the user's fingers. The gripping section 109 grips the user's fingers when the user grasps the handle housing 101 through the access region 112 defined by the enlarged opening 115 of the attached first casing member 105 and the second casing member 106 of the handle housing 101. The coupling member 118 positioned within the cavity 121 defined in the second casing member 106 of the handle housing 101 operably connects the trigger member 103 to the actuation assembly 104 within the enclosed space 107 defined within the handle housing 101 as exemplarily illustrated in FIG. 2.

When the user presses the trigger member 103, the trigger member 103 triggers 904 movement of the actuation assembly 104 via the coupling member 118 in a downward direction. The first connector 119 of the coupling member 118 rolls within the through hole 124 positioned at one opposing end 103b of the trigger member 103 and opposingly slides the coupling member 118 in a horizontal direction within the cavity 121 of the second casing member 106, causing the second connector 120 of the coupling member 118 to roll within the through hole 125 of the elongate member 113 of the actuation assembly 104 and opposingly slide the coupling member 118 in a vertical direction within the cavity 121 of the second casing member 106 for moving the actuation assembly 104 in a downward direction. When the trigger member 103 triggers movement of the actuation assembly 104 in the downward direction, the protruding element 129 of the actuation head member 111 of the actuation assembly 104 applies 905 a downward pressure on the button 602 of the electronic device 601, thereby actuating the electronic device 601, for example, for capturing an image. In this manner, the user can repeatedly aim the electronic device 601 accommodated within the device holder 102 of the grip and trigger apparatus 100 and capture multiple images, for example, with a single hand. The slider 114 positioned proximal to the upper end 113a of the elongate member 113 of the actuation assembly 104 may be used for adjusting the position of the actuation head member 111 of the actuation assembly 104. The spring member 128 facilitates the advance and retraction of the trigger member 103 for moving the actuation assembly 104 in an upward direction and a downward direction as disclosed in the detailed description of FIGS. 6A-6B.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A grip and trigger apparatus removably attachable to an electronic device for actuating said electronic device, comprising:
a handle housing comprising a first casing member detachably attached to a second casing member, wherein said detachably attached first casing member and said second casing member of said handle housing are configured to define an enclosed space and openings for accommodating a trigger member and an actuation assembly;
a device holder positioned on an upper surface of said handle housing, said device holder configured to securely accommodate said electronic device;
said trigger member extending outwardly from a side of said handle housing via one of said openings defined by said handle housing, said trigger member operably connected to said actuation assembly within said enclosed space defined within said handle housing, wherein said trigger member is configured to trigger movement of said actuation assembly in an upward direction and a downward direction; and
said actuation assembly positioned in another one of said openings defined by said handle housing, wherein said actuation assembly comprises:
an elongate member slidably positioned within said enclosed space and extending out of said another one of said openings defined by said handle housing; and
an actuation head member rigidly connected to an upper end of said elongate member, wherein said actuation head member comprises a protruding element configured to apply a downward pressure on a button of said electronic device for actuating said electronic device, when said trigger member triggers said movement of said actuation assembly in said downward direction.

2. The grip and trigger apparatus of claim 1, further comprising a coupling member positioned within a cavity defined in said second casing member of said handle housing, wherein said coupling member is configured to operably connect said trigger member to said actuation assembly within said enclosed space defined within said handle housing.

3. The grip and trigger apparatus of claim 2, wherein said coupling member comprises:
a first connector rollably connected to a through hole positioned at one opposing end of said trigger member; and
a second connector rollably connected to a through hole positioned at a lower end of said elongate member of said actuation assembly, wherein said first connector of said coupling member is configured to roll within said through hole of said trigger member and opposingly slide said coupling member in a horizontal direction within said cavity of said second casing member, causing said second connector of said coupling member to roll within said through hole of said elongate member of said actuation assembly and opposingly slide said coupling member in a vertical direction within said cavity of said second casing member for moving said actuation assembly in said upward direction and said downward direction.

4. The grip and trigger apparatus of claim 1, further comprising a spring member coaxially positioned along a length of said trigger member, wherein said spring member is configured to facilitate advance and retraction of said trigger member for moving said actuation assembly in said upward direction and said downward direction.

5. The grip and trigger apparatus of claim 1, wherein each of said first casing member and said second casing member of said handle housing comprises an enlarged opening of a predefined shape, wherein each said enlarged opening of said detachably attached first casing member and said second casing member defines an access region configured to accommodate a hand of a user.

6. The grip and trigger apparatus of claim 5, wherein inner edges defining said each said enlarged opening of said detachably attached first casing member and said second casing member of said handle housing are configured to form a gripping section, said gripping section configured to conform to fingers of said hand of said user and to allow said fingers of said user to grip said handle housing.

7. The grip and trigger apparatus of claim 1, wherein said device holder comprises a receptacle configured to accommodate said electronic device.

8. The grip and trigger apparatus of claim 1, further comprising a clamping assembly positioned within a receptacle of said device holder, wherein said clamping assembly is configured to securely accommodate and clamp said electronic device.

9. The grip and trigger apparatus of claim 1, further comprising a slider positioned proximal to said upper end of said elongate member of said actuation assembly, wherein said slider is configured to adjust a position of said actuation head member of said actuation assembly.

10. A method for actuating an electronic device, comprising:
providing a grip and trigger apparatus comprising:
a handle housing comprising a first casing member detachably attached to a second casing member, wherein said detachably attached first casing member and said second casing member of said handle housing are configured to define an enclosed space and openings for accommodating a trigger member and an actuation assembly;
a device holder positioned on an upper surface of said handle housing;
said trigger member extending outwardly from a side of said handle housing via one of said openings defined by said handle housing, said trigger member operably connected to said actuation assembly within said enclosed space defined within said handle housing; and
said actuation assembly positioned in another one of said openings defined by said handle housing, wherein said actuation assembly comprises:
an elongate member slidably positioned within said enclosed space and extending out of said another one of said openings defined by said handle housing; and
an actuation head member rigidly connected to an upper end of said elongate member, said actuation head member comprising a protruding element;
securely accommodating said electronic device in said device holder;
gripping said handle housing by a gripping section configured to conform to fingers of a user;
triggering movement of said actuation assembly by said trigger member in a downward direction; and
applying a downward pressure on a button of said electronic device by said protruding element of said actuation head member of said actuation assembly for actuating said electronic device, when said trigger member triggers said movement of said actuation assembly in said downward direction.

11. The method of claim 10, wherein said grip and trigger apparatus further comprises a coupling member positioned within a cavity defined in said second casing member of said handle housing, wherein said coupling member is configured to operably connect said trigger member to said actuation assembly within said enclosed space defined within said handle housing.

12. The method of claim 11, wherein said coupling member comprises:
a first connector rollably connected to a through hole positioned at one opposing end of said trigger member; and
a second connector rollably connected to a through hole positioned at a lower end of said elongate member of said actuation assembly, wherein said first connector of said coupling member is configured to roll within said through hole of said trigger member and opposingly slide said coupling member in a horizontal direction within said cavity of said second casing member, causing said second connector of said coupling member to roll within said through hole of said elongate member of said actuation assembly and opposingly slide said coupling member in a vertical direction within said cavity of said second casing member for moving said actuation assembly in said upward direction and said downward direction.

13. The method of claim 10, further comprising facilitating advance and retraction of said trigger member by a spring member coaxially positioned along a length of said trigger member for moving said actuation assembly in said upward direction and said downward direction.

14. The method of claim 10, wherein each of said first casing member and said second casing member of said handle housing comprises an enlarged opening of a predefined shape, wherein each said enlarged opening of said detachably attached first casing member and said second casing member defines an access region configured to accommodate a hand of said user, and wherein said gripping section of said handle housing is configured by inner edges that define said each said enlarged opening of said detachably attached first casing member and said second casing member of said handle housing.

15. The method of claim 10, further comprising adjusting position of said actuation head member of said actuation assembly by a slider positioned proximal to said upper end of said elongate member of said actuation assembly.

16. The method of claim 10, wherein said device holder comprises a receptacle configured to accommodate said electronic device.

17. The method of claim 10, further comprising clamping said electronic device within a receptacle of said device holder by a clamping assembly positioned within said receptacle of said device holder.
